(19) United States
(12) Patent Application Publication
(10) Pub. No.: US 2007/0262030 A1
(43) Pub. Date: Nov. 15, 2007

(54) Cmp Slurry Strainer

(75) Inventors: Koh Meng Fei, Singapore (SG); Poh Choon Siong, Singapore (SG); Leong Theng Wei, Singapore (SG)

Correspondence Address: GOODWIN PROCTER L.L.P, 599 LEXINGTON AVE., NEW YORK, NY, 10022, US

(73) Assignee: Systems on Silicon Manufacturing Co. Pte. Ltd., Singapore (SG)

(21) Appl. No.: 10/555,027

(22) PCT Filed: Sep. 24, 2003
(86) PCT No.: PCT/SG03/00229

§ 371 Date: Mar. 5, 2007

(51) Int. Cl. B01D 29/00; B08B 3/14; B08B 7/04

(52) U.S. Cl. 210/767; 134/110; 210/163; 210/474

(57) ABSTRACT

A slurry strainer for tungsten CMP. It is made of PVDF and has a lower, plug portion for close fitting into the top of a drain and an upper, convex portion that sits on top of the drain, with a larger diameter than the drain itself. Debris rolls off the top of the strainer, rather than blocking its through-holes. A lip around the edge improves air flow.

### FIELD OF THE INVENTION

The invention relates to strainers for use with the slurry from wafer polishing, for instance CMP (Chemical Mechanical Polishing). In particular, it relates to strainers that are useful for tungsten CMP, with improved performance.

### BACKGROUND OF THE INVENTION

CMP removes material from the top surface of a wafer until it is flat. Subsequent photolithography then takes place with the advantage of a flat base, leading to greater accuracy, with film layers built up with minimal height variation. CMP is typically used in oxide, shallow trench isolation (STI), polysilicon, tungsten and copper applications. A single CMP machine can be used for various of these or dedicated to just one of them.

CMP involves polishing with mechanical friction aided by chemical removal using a corrosive fluid. The wafer is rotated against a flexible pad, whilst a liquid chemical slurry is pumped between them.

The slurry and material removed from the wafer flow down to a floor surface of the polishing machine, where they flow into a drain, the slurry being collected for disposal. As shown in FIG. 1, the drain 10 usually has a strainer 12 removably recessed into its top to prevent larger bits of debris 14 from entering and choking the drain pipes. Those larger bits of debris 14 accumulate in the strainer 12, which allows their easy removal during cleaning of the machine. The strainer 12 also helps to prevent useful parts such as screws and washers from being lost down the pipe 10 during maintenance, if they are accidentally dropped.

One problem that arises from these recessed strainers 12 is that the accumulation of debris 14 tends to block their holes 16, which leads to slurry 18 flooding and leakage at the platen. This in turn may lead to corrosion. Additionally, this design does not allow easy passage of air for good drainage.

Tungsten CMP involves the removal of tungsten, which is quite difficult due to its hardness. This problem is alleviated by oxidising the tungsten surface, because the various oxides of tungsten are much softer. For tungsten CMP the slurry is therefore an appropriate oxidising agent, such as hydrogen peroxide (H₂O₂).

The inventors of the current invention have noted that a typical strainer in a CMP machine is made of plated steel. They have also determined that hydrogen peroxide has a corrosive effect on such steel. Thus such strainers are inevitably bound to fail after a few months of constant tungsten CMP.

### SUMMARY OF THE INVENTION

According to one aspect of the present invention, there is provided a strainer for use with wafer polishing apparatus, comprising: a plug portion, having a first width, for fitting into the top of a drain; and a convex portion mounted on the plug portion, having a second first width which is larger than the first width, for sitting above the top of a drain; wherein the strainer has through-holes passing all the way therethrough from the outer surface of the convex portion.

According to another aspect of the present invention, there is provided a strainer for use with wafer polishing apparatus and fitting into a slurry drain, wherein the strainer is made of PVDF.

According to yet another aspect, the present invention provides straining slurry from wafer polishing apparatus during tungsten chemical mechanical polishing using a strainer as defined in any one of the above aspects.

Thus the invention is able to provide a slurry strainer for tungsten CMP, made of PVDF and having a lower, plug portion for close fitting into the top of a drain and an upper, convex portion that sits on top of the drain, with a larger diameter than the drain itself. Debris rolls off the top of the strainer, rather than blocking its through-holes. A lip around the edge improves air flow.

### BRIEF DESCRIPTION OF THE DRAWINGS

The invention is now further described by way of non-limitative example with reference to the accompanying drawings, in which:

FIG. 1 is a cross-section through a known strainer;

FIG. 2 is a cross-section through a strainer according to an embodiment of the present invention; and

FIG. 3 is a top plan view of the strainer of FIG. 2.

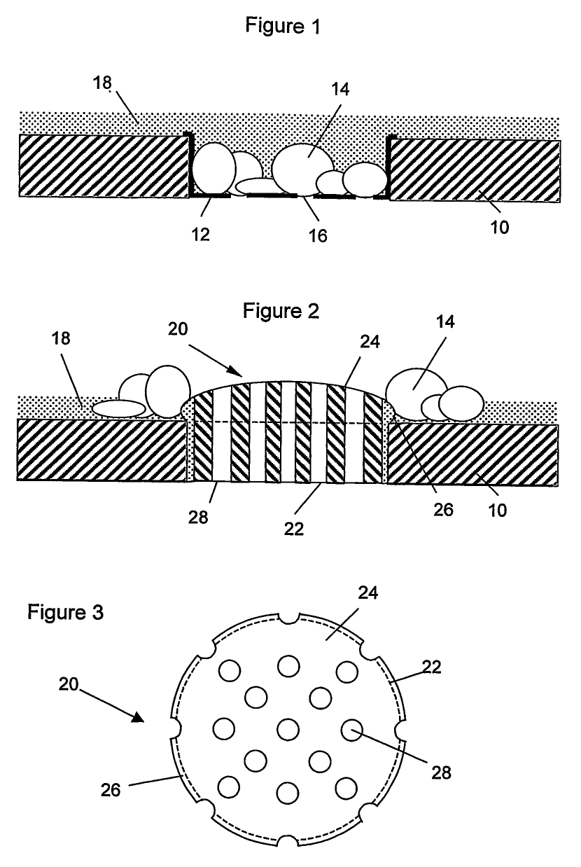

### SPECIFIC DESCRIPTION

FIG. 2 is a cross-section through a strainer 20 according to an embodiment of the present invention, in use. FIG. 3 is a top plan view of the strainer 20, although not in use.

The strainer has two parts, a plug portion 22 and a convex portion 24, the convex portion being uppermost during normal use. The plug portion 22 is generally cylindrical, being circular in plan view and having a flat bottom face. The convex portion 24 is also generally circular in plan view, with a larger diameter than the plug portion 22. Its upper surface is curved, for instance as if forming part of the surface of a sphere or spheroid. The outer edges of the convex portion 24 are also curved, curving under to form a curved lip 26 before joining the upper outer edge of the plug portion 22. Thus, from a side elevation the strainer 20 is vaguely mushroom shaped.

A number of through-holes 28 pass straight down through the strainer 20, from the outer (top) surface of the convex portion 24, through to the outer (bottom) surface of the plug portion 22. Several are spaced at different radii from the centre of the outer (top) surface of the convex portion 24. In this embodiment, some extend through the outer edges of the convex portion 24 and plug portion 22.

The plug portion 22 fits within the top of a drain 10, whilst the convex portion 24 sits above the drain (or other fluid run off port) 10. Debris 14 in the fluid flow 18 accumulates around the edges.

The plan view shape of the strainer 20 depends on the drain for which it is intended. For this embodiment it is assumed that the drain is round. For an elliptical or rectangular drain, the strainer would be shaped appropriately.

The plug portion 22 especially may be of other shapes. It could, for instance be hollow, rather than generally solid (except for the through-holes 28) as shown. Ideally the plug portion 22 should keep the strainer immobile, therefore fiting properly into the drain, but it does not have to be the same shape. For instance, it could simply consist of two transverse portions whose ends alone contact the drain.

The convex shape of what, in use, is the top surface of the strainer 20 prevents debris 14 from accumulating on top of it (at least unless there is a very large amount around). If debris is swept onto the top surface, it tends to roll off. The debris therefore settles around the circumference of the strainer 20, still allowing relatively easy cleaning.

The curved lip 26 allows easy grip of the strainer 20 for removal. Additionally, the lip 26 prevents or reduces the effect of liquid adhering to the underside and thereby blocking the flow of air through the strainer.

The strainer 20 is preferably resistant to hydrogen peroxide (H₂O₂). Polyvinylidenefluoride (PVDF) is ideally suited for such purposes, also lending itself for easy moulding to the desired shape. Further it is chemically resistant to most agents used in CMP and therefore also usable in CMP other than tungsten CMP.

1. A strainer for use with wafer polishing apparatus, comprising:
a plug portion, having a first width, for fitting into a drain; and
a convex portion mounted on the plug portion, having a second width which is larger than the first width, for sitting above the drain within which the plug portion is fitted;
wherein the strainer has through-holes passing all the way therethrough from the outer surface of the convex portion.

2. A strainer according to claim 1, wherein the convex portion further comprises a lip between its outer edge and the plug portion.

3. A strainer according to claim 1, wherein at every planar cross-section through both the plug portion and convex portion, the convex portion has a larger width than the plug portion.

4. A strainer according to claim 1, wherein the plug and convex portions are round in plan view, the convex portion being of larger diameter than the plug portion.

5. A strainer according to claim 1, wherein the through-holes pass through the plug portion and the convex portion.

6. A strainer according to claim 1, wherein the plug portion and the convex portion are integrally formed.

7. A strainer according to claim 1, made of a material that is resistant to hydrogen peroxide.

8. A strainer for use with wafer polishing apparatus and filling into a slurry drain, made of a material that is resistant to hydrogen peroxide.

9. A strainer according to claim 7, wherein said material is PVDF.

10. A method of straining slurry from wafer polishing apparatus during tungsten chemical mechanical polishing comprising using a strainer as defined in claim 1.

11. A strainer according to claim 8, wherein said material is PVDF.

12. A method of straining slurry from wafer polishing apparatus during tungsten chemical mechanical polishing comprising using a strainer as defined in claim 8.
